(19) United States
(12) Patent Application Publication
(10) Pub. No.: US 2024/0387082 A1
(43) Pub. Date: Nov. 21, 2024

(54) SMFEN-BASED ANISOTROPIC MAGNETIC POWDER AND BONDED MAGNET, AND METOHD OF PRODUCING SAID POWDER AND MAGNET

(71) Applicant: NICHIA CORPORATION, Anan-shi (JP)

(72) Inventor: Hisashi MAEHARA, Itano-gun (JP)

(73) Assignee: NICHIA CORPORATION, Anan-shi (JP)

(21) Appl. No.: 18/695,954

(22) PCT Filed: Sep. 12, 2022
(86) PCT No.: PCT/JP2022/034043

§ 371 Date: Mar. 27, 2024

(30) Foreign Application Priority Data
Sep. 27, 2021 (JP) 2021-156758

(51) Int. Cl. H01F 1/059; B22F 1/05; B22F 1/10; B22F 1/145; B22F 3/22; B22F 9/20; C22C 38/00; C22C 38/12; C22C 38/14; C23C 8/26

(52) U.S. Cl. CPC H01F 1/059; B22F 1/05; B22F 1/10; B22F 1/147; B22F 3/225; B22F 9/20; C22C 38/001; C22C 38/002; C22C 38/005; C22C 38/12; C22C 38/14; C23C 8/26; B22F 2301/355; B22F 2304/10; B22F 2998/10; B22F 2999/00; C22C 2202/02

(57) ABSTRACT

A method of producing a SmFeN-based anisotropic magnetic powder, the method including preparing a SmFeN-based anisotropic magnetic powder before dispersion containing Sm, Fe, La, W, R, and N, wherein R is at least one selected from the group consisting of Ti, Ba, and Sr, and dispersing the SmFeN-based anisotropic magnetic powder before dispersion using resin-coated metal media or resin-coated ceramic media. A SmFeN-based anisotropic magnetic powder which contains Sm, Fe, La, W, R, and N, wherein R is at least one selected from the group consisting of Ti, Ba, and Sr, and has an average particle size that is at least 2.0 μm but not more than 4.0 μm, a residual magnetization σr that is at least 152 emu/g, and an oxygen content that is not higher than 0.5% by mass.

### TECHNICAL FIELD

The present disclosure relates to a SmFeN-based anisotropic magnetic powder and a bonded magnet, and methods of producing the powder and the magnet.

### BACKGROUND ART

Patent Literature 1 discloses a production method involving grinding a SmFeN-based anisotropic magnetic powder using ceramic media in a solvent. However, it is considered that the use of hard ceramic media may cause chipping to form fine particles, so that the ground SmFeN-based anisotropic magnetic powder may have a higher oxygen content and lower magnetic properties.

### CITATION LIST

### Patent Literature

Patent Literature 1: JP 2015-195326 A

### SUMMARY OF INVENTION

### Technical Problem

A SmFeN-based anisotropic magnetic powder and a production method thereof according to embodiments of the present disclosure aim to provide a SmFeN-based anisotropic magnetic powder having excellent magnetic properties and a low oxygen content and a production method thereof. Also, a bonded magnet and a production method thereof according to embodiments of the present disclosure aim to provide a bonded magnet containing the SmFeN-based anisotropic magnetic powder and a production method thereof.

### Solution to Problem

A method of producing a SmFeN-based anisotropic magnetic powder according to embodiments of the present disclosure includes: preparing a SmFeN-based anisotropic magnetic powder before dispersion containing Sm, Fe, La, W, R, and N, wherein R is at least one selected from the group consisting of Ti, Ba, and Sr; and dispersing the SmFeN-based anisotropic magnetic powder before dispersion using resin-coated metal media or resin-coated ceramic media.

A method of producing a bonded magnet according to embodiments of the present disclosure includes: producing a SmFeN-based anisotropic magnetic powder as described above; and mixing the SmFeN-based anisotropic magnetic powder and a resin.

A SmFeN-based anisotropic magnetic powder according to embodiments of the present disclosure contains Sm, Fe, La, W, R, and N, wherein R is at least one selected from the group consisting of Ti, Ba, and Sr, and has an average particle size that is at least 2.0 μm but not more than 4.0 μm, a residual magnetization σr that is at least 152 emu/g, and an oxygen content that is not higher than 0.5% by mass.

A bonded magnet according to embodiments of the present disclosure contains a SmFeN-based anisotropic magnetic powder as described above and a resin.

### Advantageous Effects of Invention

The SmFeN-based anisotropic magnetic powder and the production method thereof according to the embodiments of the present disclosure can provide a SmFeN-based anisotropic magnetic powder having excellent magnetic properties and a low oxygen content and a production method thereof. Also, the bonded magnet and the production method thereof according to the embodiments of the present disclosure can provide a bonded magnet containing the SmFeN-based anisotropic magnetic powder and a production method thereof.

### BRIEF DESCRIPTION OF DRAWINGS

FIG. 1 shows a SEM image of a magnetic powder produced in Example 1.

FIG. 2 shows a SEM image of a magnetic powder produced in Example 2.

FIG. 3 shows a SEM image of a magnetic powder produced in Example 3.

FIG. 4 shows a SEM image of a magnetic powder produced in Comparative Example 1.

FIG. 5 shows a SEM image of a magnetic powder produced in Comparative Example 2.

### DESCRIPTION OF EMBODIMENTS

Embodiments of the present disclosure are described in detail below. The following embodiments, however, are intended as examples to embody the technical idea of the present disclosure and are not intended to limit the scope of the present disclosure to the following embodiments. As used herein, the term “step” encompasses not only an independent step but also a step that may not be clearly distinguished from other steps, as long as a desired object of the step is achieved. Moreover, numerical ranges indicated using “to” refer to ranges including the numerical values indicated before and after “to” as the minimum and maximum, respectively.

A method of producing a SmFeN-based anisotropic magnetic powder according to the present embodiments includes dispersing a SmFeN-based anisotropic magnetic powder containing Sm, Fe, La, W, R, and N, wherein R is at least one selected from the group consisting of Ti, Ba, and Sr, using resin-coated metal media or resin-coated ceramic media. The method of producing a SmFeN-based anisotropic magnetic powder according to the present embodiments includes preparing a SmFeN-based anisotropic magnetic powder before dispersion containing Sm, Fe, La, W, R, and N, wherein R is at least one selected from the group consisting of Ti, Ba, and Sr, and the dispersion step includes dispersing such a SmFeN-based anisotropic magnetic powder before dispersion using the media.

### Dispersion Step

A SmFeN-based anisotropic magnetic powder containing Sm, Fe, La, W, R, and N, wherein R is at least one selected from the group consisting of Ti, Ba, and Sr, may be dispersed using resin-coated metal media or resin-coated ceramic media. Here, the term “dispersion”, “dispersing”, or “dispersed” means that the aggregated particles in the SmFeN-based anisotropic magnetic powder formed by sintering or magnetic aggregation are separated into single particles or particles consisting of very few particles (hereinafter, referred to as single particles). Moreover, when the SmFeN-based anisotropic magnetic powder collides with the resin-coated metal media or resin-coated ceramic media, since the energy of collision between them is smaller than that between the SmFeN-based anisotropic magnetic powder and non-resin coated metal media or non-resin coated ceramic media, dispersion is more likely to occur than grinding. If the SmFeN-based anisotropic magnetic powder is ground as in the conventional art, the average particle size will be greatly reduced, and fine particles will also be formed due to chipping, with the result that the magnetic properties are likely to be degraded. Moreover, since highly active new surfaces are generated on the fine particles and on the parts from which the fine particles are produced, oxidation is likely to occur, resulting in a higher oxygen content. In contrast, when dispersion is performed as in the present embodiments, it is believed that the formed single particles can be easily oriented in a magnetic field to enhance the magnetic properties; further, the generation of new surfaces associated with fine particle formation can be suppressed as compared to when grinding is performed, so that the oxygen content is less likely to increase.

The dispersion apparatus used in the dispersion step may be a vibration mill, for example. The media used in the dispersion apparatus such as vibration mill may include a metal core and a resin coating the metal core. Examples of the metal material include iron, chromium steel, stainless steel, and steel. The media used in the dispersion apparatus such as vibration mill may also include a ceramic core and a resin coating the ceramic core. Examples of the ceramic material include inorganic compounds such as oxides, carbides, nitrides, or borides of metals or non-metals. Specific examples include alumina, silica, zirconia, silicon carbide, silicon nitride, barium titanate, and glass. Iron and chromium steel are preferred among these because they have a high dispersing ability owing to the high specific gravity and less wear owing to the high hardness, and also because the iron-containing wear powder generated by abrasion has a low impact on the SmFeN-based anisotropic magnetic powder. Thus, resin-coated iron media or resin-coated chromium steel media are preferably used in the dispersion apparatus. Examples of the coating resin include thermoplastic resins such as nylon 6, nylon 66, nylon 12, polypropylene, polyphenylene sulfide, and polyethylene, thermosetting resins such as epoxy resins and silicone resins, and combinations thereof. Thermoplastic resins can be formed by injection molding, and the fluidity of thermoplastic resins is higher than the fluidity of thermosetting resins. Therefore, the thickness of a thermoplastic resin coating can be smaller than that of a thermosetting resin coating. Thermoplastic resin-coated media can thus have a higher specific gravity and a smaller size than those of thermosetting resin-coated media. Nylon such as nylon 6, nylon 66, or nylon 12 is preferred among thermoplastic resins, because nylon is relatively soft and inexpensive among thermoplastic resins. For example, nylon-coated iron media may be used in the dispersion apparatus. In this case, the SmFeN-based anisotropic magnetic powder can be dispersed while further suppressing the generation of fine powder.

The media used in the dispersion step preferably has a specific gravity of at least 4, more preferably at least 5. When the specific gravity is less than 4, the collision energy during the dispersion tends to be too small, so that dispersion is less likely to occur. The upper limit of the specific gravity is not limited, but is preferably not more than 8, more preferably not more than 7.5. The media used in the dispersion step may have a specific gravity of at least 6 but not more than 7.5. The resin-coated metal media or resin-coated ceramic media can be translated as media including a metal or ceramic core and a resin film coating the core. For example, the thickness of the resin film may be at least 0.1 μm but not more than 5 mm. This is suitable for dispersing the SmFeN-based anisotropic magnetic powder because an increase in the diameter of the media can be suppressed. Therefore, the or of the obtained SmFeN-based anisotropic magnetic powder can be improved.

Although the dispersion step may be performed in the presence of a solvent, it is preferably performed in the absence of a solvent in order to suppress the oxidation of the SmFeN-based anisotropic magnetic powder by the components (e.g., moisture) in the solvent.

To suppress oxidation of the SmFeN-based anisotropic magnetic powder, the dispersion step is preferably performed in an inert gas atmosphere such as nitrogen gas atmosphere or argon gas atmosphere. The concentration of nitrogen in the nitrogen gas atmosphere may be 90% by volume or more, preferably 95% by volume or more. The concentration of argon in the argon gas atmosphere may be 90% by volume or more, preferably 95% by volume or more. The inert gas atmosphere may be an atmosphere in which two or more inert gases such as nitrogen gas and argon gas are mixed. The concentration of inert gas in the inert gas atmosphere may be 90% by volume or more, preferably 95% by volume or more.

The diameter of the resin-coated metal media or resin-coated ceramic media is preferably at least 2 mm but not more than 100 mm, more preferably at least 3 mm but not more than 15 mm, still more preferably at least 3 mm but not more than 10 mm. The media having a diameter of less than 2 mm are difficult to coat with the resin, while the media having a diameter of more than 100 mm are large and thus tend to have less contact with the powder, so that dispersion is less likely to occur.

When a vibration mill is used in the dispersion step, for example, the amount of the media may be at least 60% by volume but not more than 70% by volume, and the amount of the SmFeN-based anisotropic magnetic powder may be at least 3% by volume but not more than 25% by volume, preferably at least 4% by volume but not more than 20% by volume, each relative to the volume of the container used to contain the SmFeN-based anisotropic magnetic powder and the media.

### Preparation Step

The dispersion step is preceded by preparing a SmFeN-based anisotropic magnetic powder before dispersion. The step of preparing a SmFeN-based anisotropic magnetic powder before dispersion is a step of producing a SmFeN-based anisotropic magnetic powder, for example. Although the SmFeN-based anisotropic magnetic powder before dispersion used in the dispersion step may be produced with reference to the method disclosed in, for example, JP 2017-117937 A or JP 2021-055188 A, an exemplary method of producing the SmFeN-based anisotropic magnetic powder before dispersion will be described below. Here, the SmFeN-based anisotropic magnetic powder before dispersion is a magnetic powder before the dispersion step using the resin-coated metal media or resin-coated ceramic media described above, and may have undergone other pre-dispersion steps.

The SmFeN-based anisotropic magnetic powder before dispersion used in the dispersion step may be produced by a production method including:
a pretreatment including heat-treating an oxide containing Sm, Fe, La, W, and R, wherein R is at least one selected from the group consisting of Ti, Ba, and Sr, in a reducing gas-containing atmosphere to obtain a partial oxide;
heat-treating the partial oxide in the presence of a reducing agent to obtain alloy particles;
nitriding the alloy particles to obtain a nitride; and
washing the nitride to obtain the SmFeN-based anisotropic magnetic powder before dispersion.

Although the oxide containing Sm, Fe, La, W, and R, wherein R is at least one selected from the group consisting of Ti, Ba, and Sr, used in the pretreatment step may be prepared by mixing a Sm oxide, a Fe oxide, a La oxide, a W oxide, and a R oxide, it can be produced by mixing a solution containing Sm, Fe, La, W, and R with a precipitating agent to obtain a precipitate containing Sm, Fe, La, W, and R (precipitation step), and firing the precipitate to obtain an oxide containing Sm, Fe, La, W, and R (oxidation step).

### Precipitation Step

In the precipitation step, a Sm source, a Fe source, a La source, a W source, and a R source may be dissolved to prepare a solution containing Sm, Fe, La, W, and R. When the main phase to be obtained is Sm₂Fe₁₇N₃, the molar ratio of Sm and Fe (Sm:Fe) is preferably 1.5:17 to 3.0:17, more preferably 2.0:17 to 2.5:17. Due to the presence of La, W, and R, a magnetic material with a high remanence can be obtained. In addition to La, W, and R, other sources such as Co, Sc, Y, Pr, Nd, Pm, Gd, Tb, Dy, Ho, Er, Tm, and Lu may be added to the aforementioned solution.

The Sm source, the Fe source, the La source, the W source, and the R source are not limited as long as they are soluble. In view of availability, examples of the Sm source include samarium oxide; examples of the Fe source include FeSO₄; examples of the La source include La₂O₃ and LaCl₃; examples of the W source include ammonium tungstate; and examples of the R source include oxides of R (titanium oxide, strontium oxide, barium oxide), carbonates of R (strontium carbonate, barium carbonate), chlorides of R (strontium chloride, barium chloride), and sulfates of R (titanium sulfate). The concentration of the solution containing Sm, Fe, La, W, and R may be appropriately adjusted within a range in which the Sm source, Fe source, La source, W source, and R source can be substantially dissolved in the solution.

The solution containing Sm, Fe, La, W, and R may be reacted with a precipitating agent to obtain an insoluble precipitate containing Sm, Fe, La, W, and R. Here, the solution containing Sm, Fe, La, W, and R is not limited as long as Sm, Fe, La, W, and R are present in the solution during the reaction with the precipitating agent. For example, a Sm-containing solution, a Fe-containing solution, a La-containing solution, a W-containing solution, and a R-containing solution may be prepared separately from each other and individually added dropwise to react with the precipitating agent. Alternatively, the solution containing Sm, Fe, La, W, and R may be such that a solution containing Sm and Fe and a solution containing La, W, and R are prepared separately from each other and individually added dropwise to react with the precipitating agent. When separate solutions are prepared, they may also be appropriately adjusted within a range in which the sources can be substantially dissolved in the respective solutions. The precipitating agent may be any alkaline solution that can react with the solution containing Sm, Fe, La, W, and R to give a precipitate. Examples include ammonia water and caustic soda, with caustic soda being preferred.

To easily control the particle properties of the precipitate, the precipitation reaction is preferably performed by adding dropwise the solution containing Sm, Fe, La, W, and R and the precipitating agent each to a solvent such as water. A precipitate having a homogeneous element distribution, a narrow particle size distribution, and a uniform particle shape can be obtained by appropriately controlling the feeding rates of the solution containing Sm, Fe, La, W, and R and the precipitating agent, the reaction temperature, the concentration of the reaction solution, the pH during the reaction, and other conditions. The use of such a precipitate improves the magnetic properties of the finally produced SmFeN-based anisotropic magnetic powder. The reaction temperature is preferably at least 0° C. but not higher than 50° C., more preferably at least 35° C. but not higher than 45° C. The concentration of the reaction solution calculated as the total concentration of metal ions is preferably at least 0.65 mol/L but not more than 0.85 mol/L, more preferably at least 0.7 mol/L but not more than 0.85 mol/L. The reaction pH is preferably at least 5 but not more than 9, more preferably at least 6.5 but not more than 8.

The powder obtained in the precipitation step roughly determines the powder particle size, particle shape, and particle size distribution of the finally produced SmFeN-based anisotropic magnetic powder. When the particle size of the obtained powder is measured with a laser diffraction-type wet particle size distribution analyzer, the size and distribution of all the powder may preferably substantially fall within the range of at least 0.05 μm but not more than 20 μm, preferably at least 0.1 μm but not more than 10 μm.

After separating the precipitate, the separated precipitate is preferably subjected to solvent removal in order to reduce aggregation of the precipitate caused by evaporation of the residual solvent in which the precipitate has been re-dissolved during the heat treatment in the subsequent oxidation step, and to reduce changes in properties such as particle size distribution and powder particle size. Specifically, when the solvent used is water, for example, the solvent removal may be performed by drying in an oven at a temperature of at least 70° C. but not higher than 200° C. for at least 5 hours but not longer than 12 hours.

The precipitation step may be followed by washing and separating the resulting precipitate. The washing process may be appropriately performed until the conductivity of the supernatant solution reaches 5 mS/m² or lower. The precipitate separation process may be performed, for example, by mixing the resulting precipitate with a solvent (preferably water), followed by filtration, decantation, or other separation methods.

### Oxidation Step

The oxidation step includes firing the precipitate formed in the precipitation step to obtain an oxide containing Sm, Fe, La, W, and R. For example, the precipitate may be converted into an oxide by heat treatment. The heat treatment of the precipitate needs to be performed in the presence of oxygen, for example in an air atmosphere. Moreover, as the presence of oxygen is necessary, the non-metal portions of the precipitate preferably contain oxygen atoms.

The heat treatment temperature in the oxidation step (hereinafter, oxidation temperature) is not limited, but is preferably at least 700° C. but not higher than 1300° C., more preferably at least 900° C. but not higher than 1200° C. If the oxidation temperature is lower than 700° C., the oxidation tends to be insufficient. If the oxidation temperature is higher than 1300° C., the resulting SmFeN-based anisotropic magnetic powder tends not to have the target particle shape, average particle size, and particle size distribution. The heat treatment duration is not limited either, but is preferably at least one hour but not longer than three hours.

The thus produced oxide is oxide particles in which Sm and Fe have been sufficiently microscopically mixed, and the particle shape, particle size distribution, and other properties of the precipitate have been reflected.

### Pretreatment Step

The pretreatment step includes subjecting the aforementioned oxide containing Sm, Fe, La, W, and R to heat treatment in a reducing gas-containing atmosphere to obtain a partial oxide which is a partially reduced product of the oxide.

Here, the term “partial oxide” refers to a partially reduced oxide. The oxygen concentration of the partial oxide is not limited, but is preferably not more than 10% by mass, more preferably not more than 8% by mass. If the oxygen concentration is more than 10% by mass, the heat generated by reduction with Ca in the reduction step tends to increase, raising the firing temperature and thus forming abnormally grown particles. Here, the oxygen concentration of the partial oxide can be measured by a non-dispersive infrared spectroscopy (ND-IR).

The reducing gas may be appropriately selected from, for example, hydrogen (H₂), carbon monoxide (CO), hydrocarbon gases such as methane (CH₄), and combinations thereof. Hydrogen gas is preferred in terms of cost. The flow rate of the gas may be appropriately adjusted within a range that does not cause scattering of the oxide. The heat treatment temperature in the pretreatment step (hereinafter, pretreatment temperature) is preferably at least 300° C. but not higher than 950° C. The lower limit is more preferably at least 400° C., still more preferably at least 750° C. The upper limit is more preferably lower than 900° C. When the pretreatment temperature is at least 300° C., the oxide containing Sm, Fe, La, W, and R can be efficiently reduced. Also, when the pretreatment temperature is not higher than 950° C., the grain growth and segregation of the oxide particles can be inhibited, so that the desired particle size can be maintained. The heat treatment duration is not limited but may be at least 1 hour but not longer than 50 hours. Moreover, when the reducing gas used is hydrogen, preferably the thickness of the oxide layer used is adjusted to not more than 20 mm, and further the dew point in the reaction furnace is adjusted to not higher than −10° C.

### Reduction Step

The reduction step includes heat-treating the partial oxide in the presence of a reducing agent to obtain alloy particles. For example, the reduction may be performed by bringing the partial oxide into contact with molten calcium or calcium vapor. In view of magnetic properties, the heat treatment temperature is preferably at least 920° C. but not higher than 1200° C., more preferably at least 950° C. but not higher than 1150° C., still more preferably at least 1000° C. but not higher than 1100° C.

As an alternative to the above-described heat treatment process in the reduction step, heat treatment may be performed at a first temperature of at least 950° C. but not higher than 1150° C. and then at a second temperature lower than the first temperature of at least 930° C. but not higher than 1130° C. The first temperature is preferably at least 1000° C. but not higher than 1100° C., and the second temperature is preferably at least 980° C. but not higher than 1080° C. With regard to the difference between the first temperature and the second temperature, the second temperature is preferably lower than the first temperature by a range of at least 10° C. but not more than 60° C., more preferably by a range of at least 10° C. but not more than 30° C. The heat treatment at the first temperature and the heat treatment at the second temperature may be continuously performed. Although heat treatment at a temperature lower than the second temperature may be included between these heat treatments, it is preferred in view of productivity to perform these treatments continuously. To perform a more uniform reduction reaction, the duration of each heat treatment is preferably shorter than 120 minutes, more preferably shorter than 90 minutes. The lower limit of the heat treatment duration is preferably not shorter than 10 minutes, more preferably not shorter than 30 minutes.

The metallic calcium serving as a reducing agent may be used in the form of granules or powder, and its average particle size is preferably 10 mm or less in order to more effectively suppress aggregation during the reduction reaction. Moreover, the amount of the metallic calcium added is preferably at least 1.1 times but not more than 3.0 times, more preferably at least 1.5 times but not more than 2.5 times the reaction equivalent (which is the stoichiometric amount needed to reduce the rare earth oxides, but includes the amount needed to reduce an oxide of the Fe component, if present.).

In the reduction step, the metallic calcium as a reducing agent may be used in combination with a disintegration accelerator, if necessary. The disintegration accelerator may be appropriately used to facilitate the disintegration or granulation of the product during the post treatment step described later. Examples include alkaline earth metal salts such as calcium chloride and alkaline earth oxides such as calcium oxide. Such a disintegration accelerator may be used in an amount of at least 1% by mass but not more than 30% by mass, preferably at least 5% by mass but not more than 30% by mass, relative to the amount of the samarium oxide.

### Nitridation Step

The nitridation step includes nitriding the alloy particles obtained in the reduction step to obtain anisotropic magnetic particles. As the particulate precipitate obtained in the precipitation step described above is used, the alloy particles obtained in the reduction step are in porous bulk form. This permits the alloy particles to be directly nitrided by heat treatment in a nitrogen atmosphere without grinding, resulting in uniform nitridation.

The heat treatment temperature in the nitridation of the alloy particles (hereinafter, nitridation temperature) is preferably at least 300° C. but not higher than 610° C., particularly preferably at least 400° C. but not higher than 550° C., and the atmosphere may be replaced with nitrogen to perform the nitridation in this temperature range. The heat treatment duration may be selected such that the alloy particles can be sufficiently uniformly nitrided.

With regard to the heat treatment temperature in the nitridation of the alloy particles, heat treatment for nitridation may be performed at a first temperature of at least 400° C. but not higher than 470° C. and then at a second temperature of at least 480° C. but not higher than 610° C. If the alloy particles are heat-treated at the high second temperature without being nitrided at the first temperature, the nitridation may rapidly proceed to cause abnormal heat generation, which can degrade the SmFeN-based anisotropic magnetic powder, greatly reducing the magnetic properties. Moreover, the nitridation step is preferably performed in a substantially nitrogen-containing atmosphere in order to allow the nitridation to proceed more slowly.

Here, the term “substantially” is used in consideration of the potential presence of unavoidable element(s) other than nitrogen due to contamination of impurities or other factors. For example, the nitrogen content of the atmosphere is not lower than 95%, preferably not lower than 97%, more preferably not lower than 99%.

The first temperature in the nitridation step is preferably at least 400° C. but not higher than 470° C., more preferably at least 410° C. but not higher than 450° C. If the first temperature is lower than 400° C., the nitridation tends to proceed very slowly. If the first temperature is higher than 470° C., excessive nitridation or degradation tends to easily occur due to heat generation. The heat treatment duration at the first temperature is not limited but is preferably at least 1 hour but not longer than 40 hours, more preferably not longer than 20 hours. If the heat treatment duration is shorter than 1 hour, the nitridation may insufficiently proceed. If the heat treatment duration is longer than 40 hours, productivity is impaired.

The second temperature is preferably at least 480° C. but not higher than 610° C., more preferably at least 500° C. but not higher than 550° C. If the second temperature is lower than 480° C., the nitridation of large particles may insufficiently proceed. If the second temperature is higher than 610° C., excessive nitridation or degradation can easily occur. The heat treatment duration at the second temperature is preferably at least 15 minutes but not longer than 5 hours, more preferably at least 30 minutes but not longer than 2 hours. If the heat treatment duration is shorter than 15 minutes, the nitridation may insufficiently proceed. If the heat treatment duration is longer than 5 hours, productivity is impaired.

The heat treatment at the first temperature and the heat treatment at the second temperature may be continuously performed. Although heat treatment at a temperature lower than the second temperature may be included between these heat treatments, it is preferred in view of productivity to perform these treatments continuously.

### Post Treatment Step

The product obtained after the nitridation step may contain, in addition to the magnetic particles, materials such as by-product CaO and unreacted metallic calcium, which may be combined into sintered bulk form. The product obtained after the nitridation step may be introduced into cold water to separate the CaO and metallic calcium as a suspension of calcium hydroxide (Ca(OH)₂) from the SmFeN-based anisotropic magnetic powder. Further, the residual calcium hydroxide may be sufficiently removed by washing the SmFeN-based anisotropic magnetic powder with acetic acid or the like. When the product is introduced into water, oxidation of metallic calcium by water and hydration of by-product CaO will occur, causing disintegration, i.e., micronization, of the reaction product that has been combined into sintered bulk form.

### Alkali Treatment Step

The product obtained after the nitridation step may be introduced into an alkali solution. Examples of the alkali solution used in the alkali treatment step include an aqueous calcium hydroxide solution, an aqueous sodium hydroxide solution, and an aqueous ammonia solution. In view of wastewater treatment and high pH, an aqueous calcium hydroxide solution or an aqueous sodium hydroxide solution is preferred among these. In the alkali treatment of the product obtained after the nitridation step, the remaining Sm-rich layer containing a certain amount of oxygen serves as a protection layer, thereby reducing an increase in oxygen concentration caused by the alkali treatment.

The pH of the alkali solution used in the alkali treatment step is not limited, but is preferably at least 9, more preferably at least 10. If the pH is less than 9, the rate of the reaction into calcium hydroxide is higher, causing greater heat generation. Thus, the finally produced SmFeN-based anisotropic magnetic powder tends to have a higher oxygen concentration.

In the alkali treatment step, the SmFeN-based anisotropic magnetic powder obtained after the treatment with the alkali solution may optionally be subjected to decantation or other techniques to reduce the moisture.

### Acid Treatment Step

The alkali treatment step may further be followed by treatment with an acid. In the acid treatment step, the above-described Sm-rich layer may be at least partially removed to reduce the oxygen concentration of the magnetic powder as a whole. Moreover, since the production method according to the present embodiments does not include grinding or the like, the SmFeN-based anisotropic magnetic powder has a small average particle size and a narrow particle size distribution, and also does not contain fine powder formed by grinding or the like, which makes it possible to reduce an increase in oxygen concentration.

Any acid may be used in the acid treatment step, and examples include hydrogen chloride, nitric acid, sulfuric acid, and acetic acid. To avoid residual impurities, hydrogen chloride or nitric acid is preferred among these.

The amount of the acid used in the acid treatment step per 100 parts by mass of the SmFeN-based anisotropic magnetic powder is preferably at least 3.5 parts by mass but not more than 13.5 parts by mass, more preferably at least 4 parts by mass but not more than 10 parts by mass. If the amount is less than 3.5 parts by mass, the oxide tends to remain on the surface of the SmFeN-based anisotropic magnetic powder, resulting in a higher oxygen concentration. If the amount is more than 13.5 parts by mass, reoxidation is more likely to occur upon exposure to the air, and the cost also tends to increase because the acid dissolves the SmFeN-based anisotropic magnetic powder. When the amount of the acid is at least 3.5 parts by mass but not more than 13.5 parts by mass per 100 parts by mass of the SmFeN-based anisotropic magnetic powder, the surface of the SmFeN-based anisotropic magnetic powder can be covered with the Sm-rich layer oxidized enough to inhibit reoxidation upon exposure to the air after the acid treatment. Thus, the resulting SmFeN-based anisotropic magnetic powder has a low oxygen concentration, a small average particle size, and a narrow particle size distribution.

In the acid treatment step, the SmFeN-based anisotropic magnetic powder obtained after the treatment with the acid may optionally be subjected to decantation or other techniques to reduce the moisture.

### Dehydration Step

The acid treatment step is preferably followed by dehydration. The dehydration can reduce the moisture in the solids before vacuum drying, thereby inhibiting the progress of oxidation during drying caused due to the higher moisture content of the solids before vacuum drying. Here, the term “dehydration” refers to a treatment in which a pressure or a centrifugal force is applied to reduce the moisture content of the solids after the treatment as compared to that of the solids before the treatment, and excludes mere decantation, filtration, or drying. The dehydration may be performed by any method such as squeezing or centrifugation.

The moisture content of the SmFeN-based anisotropic magnetic powder after the dehydration is not limited, but is preferably not higher than 13% by mass, more preferably not higher than 10% by mass, in order to inhibit the progress of oxidation.

The SmFeN-based anisotropic magnetic powder obtained by the acid treatment or the SmFeN-based anisotropic magnetic powder obtained by the acid treatment and subsequent dehydration is preferably dried in vacuum. The drying temperature is not limited, but is preferably not lower than 70° C., more preferably not lower than 75° C. The drying duration is not limited either, but is preferably not shorter than 1 hour, more preferably not shorter than 3 hours.

### Surface Treatment Step

The SmFeN-based anisotropic magnetic powder obtained in the post treatment step may be subjected to surface treatment. For example, a phosphoric acid solution as a surface treatment agent may be introduced in an amount in the range of at least 0.10% by mass but not more than 10% by mass, calculated as PO₄, relative to the solids content of the magnetic particles obtained in the nitridation step. The magnetic particles may be appropriately separated from the solution and dried to obtain a phosphoric acid-treated SmFeN-based anisotropic magnetic powder. In the surface treatment step, a silica film or a coupling agent film may be formed on the surface of the SmFeN-based anisotropic magnetic powder. When the SmFeN-based anisotropic magnetic powder is used to produce a bonded magnet, it may have undergone at least one of these surface treatments. For example, a bonded magnet may be produced from the SmFeN-based anisotropic magnetic powder that has been subjected to phosphoric acid treatment, silica film formation, and coupling agent film formation in the stated order. This allows the resulting bonded magnet to have an improved coercive force.

The SmFeN-based anisotropic magnetic powder according to embodiments of the present disclosure contains Sm, Fe, La, W, R, and N, wherein R is at least one selected from the group consisting of Ti, Ba, and Sr, and has an average particle size that is at least 2.0 μm but not more than 4.0 μm, a residual magnetization σr that is at least 152 emu/g, and an oxygen content that is not higher than 0.5% by mass.

In view of magnetic properties, the average particle size of the SmFeN-based anisotropic magnetic powder is, for example, at least 2.0 μm but not more than 4.0 μm, preferably at least 2.3 μm but not more than 3.5 μm. Here, the term “average particle size” refers to the particle size measured using a laser diffraction particle size distribution analyzer under a dry condition.

The particle size D10 of the SmFeN-based anisotropic magnetic powder is preferably at least 0.5 μm, more preferably at least 1.0 μm. If the D10 is less than 0.5 μm, the magnetization of the SmFeN-based anisotropic magnetic powder tends to greatly decrease. Here, the term “D10” refers to the particle size corresponding to 10% of the cumulative particle size distribution by volume of the SmFeN-based anisotropic magnetic powder.

The particle size D50 of the SmFeN-based anisotropic magnetic powder is preferably at least 2.0 μm but not more than 3.5 μm, more preferably at least 2.5 μm but not more than 3.2 μm. If the D50 is less than 2.0 μm, the amount of the SmFeN-based anisotropic magnetic powder filled in the bonded magnet tends to decrease, resulting in lower magnetization. If the D50 is more than 3.5 μm, the magnetic powder tends to aggregate, resulting in lower magnetic properties. Here, the term “D50” refers to the particle size corresponding to 50% of the cumulative particle size distribution by volume of the SmFeN-based anisotropic magnetic powder.

The particle size D90 of the SmFeN-based anisotropic magnetic powder is preferably at least 3.5 μm but not more than 5.5 μm, more preferably at least 4.0 μm but not more than 5.0 μm. If the D90 is less than 3.5 μm, the amount of the SmFeN-based anisotropic magnetic powder filled in the bonded magnet tends to decrease, resulting in lower magnetization. If the D90 is more than 5.5 μm, the coercive force of the bonded magnet tends to decrease. Here, the term “D90” refers to the particle size corresponding to 90% of the cumulative particle size distribution by volume of the SmFeN-based anisotropic magnetic powder.

The residual magnetization σr of the SmFeN-based anisotropic magnetic powder is at least 152 emu/g, preferably at least 153 emu/g. The coercive force iHc can be at least 6000 Oe but not more than 20000 Oe or may be at least 7000 Oe but not more than 12000 Oe. The squareness ratio Hk can be at least 3000 Oe but not higher than 10000 Oe or may be at least 5000 Oe but not higher than 7000 Oe.

The oxygen content in the SmFeN-based anisotropic magnetic powder is not higher than 0.5% by mass, preferably not higher than 0.4% by mass, more preferably not higher than 0.35% by mass. If the oxygen content is more than 0.5% by mass, a lot of oxygen can be present on the particle surface, causing the formation of α-Fe. Here, the oxygen content is analyzed after the SmFeN-based anisotropic magnetic powder obtained after completion of all the steps is allowed to stand in the air for at least 30 minutes.

The SmFeN-based anisotropic magnetic powder according to the present embodiments is typically represented by the following formula:

SmᵥFe_{(100-v-w-x-y-z)}N_{w}LaₓW_{y}R_{z}

wherein 3≤v≤30, 5≤w≤15, 0.05≤x≤0.3, 0.05≤y≤2.5, and 0.0001≤z≤0.3.

In the formula, v is defined to be at least 3 but not more than 30 for the following reason. If v is less than 3, the unreacted iron component (α-Fe phase) may be separated, which reduces the coercive force of the SmFeN-based anisotropic magnetic powder, thus failing to provide a practical magnet. If v is more than 30, the Sm element may precipitate and make the SmFeN-based anisotropic magnetic powder unstable in the air, thus reducing the remanence. Moreover, w is defined to be at least 5 but not more than 15 for the following reason. If w is less than 5, almost no coercive force may be obtained. If w is more than 15, a nitride of Sm or iron itself may be formed. Moreover, x is defined to be at least 0.05 but not more than 0.3 for the following reason. If x is less than 0.05, the effect of the addition may be insufficient. If x is more than 0.3, a nitride of Sm or iron itself may be formed, greatly reducing the magnetization. Moreover, y is defined to be at least 0.05 but not more than 2.5 for the following reason. If y is less than 0.05, the effect of the addition may be insufficient. If y is more than 2.5, a nitride of Sm or iron itself may be formed, greatly reducing the magnetization. Moreover, z is defined to be at least 0.0001 but not more than 0.3 for the following reason. If z is less than 0.0001, the effect of the addition may be insufficient. If z is more than 0.3, a nitride of Sm or iron itself may be formed, greatly reducing the magnetization.

In view of remanence, the amount of La is preferably at least 0.1% by mass but not more than 5% by mass, more preferably at least 0.15% by mass but not more than 1% by mass.

In view of coercive force, the amount of W is preferably at least 0.1% by mass but not more than 5% by mass, more preferably at least 0.15% by mass but not more than 1% by mass.

In view of temperature characteristics, the amount of R is preferably not more than 1.0% by mass, more preferably not more than 0.5% by mass.

The amount of N is preferably at least 3.3% by mass but not more than 3.5% by mass. If the amount is more than 3.5% by mass, excessive nitridation may occur. If the amount is less than 3.3% by mass, insufficient nitridation may occur. In both cases, the magnetic properties tend to be degraded.

The SmFeN-based anisotropic magnetic powder preferably has a below-defined span of not more than 2, more preferably not more than 1.8, still more preferably not more than 1.6, particularly preferably not more than 1.3.

$$Span = ( D 90 - D 10 ) / D 50$$

In the equation, D10, D50, and D90 represent the particle sizes corresponding to 10%, 50%, and 90%, respectively, of the cumulative particle size distribution by volume. If the span is more than 2, larger particles are present, and therefore the magnetic properties tend to be degraded.

The average circularity of the SmFeN-based anisotropic magnetic powder is preferably at least 0.50, more preferably at least 0.70, particularly preferably at least 0.75. If the circularity is less than 0.50, the fluidity may deteriorate so that stress can occur between the particles during the magnetic field compaction, resulting in lower magnetic properties. The circularity can be determined using a scanning electron microscope (SEM) and a particle analysis Ver. 3 available from Sumitomo Metal Technology, Inc. as image analysis software. The circularity may be determined by taking a SEM image at a magnification of 3000, processing the image for binarization, and calculating the circularity of each particle. The term “circularity” defined in the present disclosure refers to the average of the circularities determined by measuring about 1,000 to 10,000 particles. In general, the larger the number of small size particles, the higher the circularity. Hence, particles having a particle size that is at least 1 μm are measured for circularity. The circularity measurement uses the definitional equation: Circularity=4 πS/L², wherein S represents the area of the two-dimensional projection of the particle, and L represents the perimeter of the two-dimensional projection thereof.

The SmFeN-based anisotropic magnetic powder according to the present embodiments has high residual magnetization and is thus usable as a sintered magnet or a bonded magnet, for example.

A bonded magnet can be produced from the SmFeN-based anisotropic magnetic powder according to the present embodiments and a resin. The inclusion of the SmFeN-based anisotropic magnetic powder enables the formation of a composite material having high magnetic properties. A method of producing a bonded magnet includes producing a SmFeN-based anisotropic magnetic powder by the method according to the present embodiments, and mixing the SmFeN-based anisotropic magnetic powder and a resin. The method of producing a bonded magnet may further include heat-treating a composite material obtained by mixing the SmFeN-based anisotropic magnetic powder and the resin, while aligning the easy axes of magnetization in an orientation field, followed by pulse-magnetizing the composite material in a magnetizing field.

The resin contained in the composite material may be either a thermosetting resin or a thermoplastic resin, preferably a thermoplastic resin. Specific examples of the thermoplastic resin include polyphenylene sulfide resins (PPS), polyether ether ketones (PEEK), liquid crystal polymers (LCP), polyamides (PA), polypropylenes (PP), and polyethylenes (PE).

The mass ratio of the resin to the SmFeN-based anisotropic magnetic powder (resin/SmFeN-based anisotropic magnetic powder) used to obtain the composite material is preferably at least 0.05 but not higher than 0.20 and may be at least 0.10 but not higher than 0.15 or may be at least 0.11 but not higher than 0.14. Moreover, the filling ratio of the SmFeN-based anisotropic magnetic powder in the composite material is preferably at least 50% by volume but not higher than 75% by volume, more preferably at least 60% by volume but not higher than 70% by volume, still more preferably at least 65% by volume but not higher than 70% by volume.

For example, the composite material may be obtained by mixing the SmFeN-based anisotropic magnetic powder and the resin using a kneader at a temperature of at least 200° C. but not higher than 350° C. The temperature during the mixing may be at least 280° C. but not higher than 330° C.

The bonded magnet can be produced from the composite material. Specifically, for example, the bonded magnet may be produced by heat-treating the composite material while aligning the easy axes of magnetization in an orientation field (orientation step), followed by pulse magnetization in a magnetizing field (magnetization step).

The heat treatment temperature in the orientation step is preferably, for example, at least 90° C. but not higher than 200° C., more preferably at least 100° C. but not higher than 150° C. The magnitude of the orientation field in the orientation step may be, for example, 720 kA/m, while the magnitude of the magnetizing field in the magnetization step may be, for example, at least 1500 kA/m but not more than 2500 kA/m.

The method of producing a bonded magnet may include injection-molding the composite material (bonded magnet compound). The molding temperature in the injection molding is not limited and may be selected appropriately depending on the processing temperature of the thermoplastic resin used.

When the SmFeN-based anisotropic magnetic powder according to the present embodiments is used to produce a bonded magnet, the obtained bonded magnet can have high magnetic properties. The bonded magnet contains the SmFeN-based anisotropic magnetic powder according to the present embodiments and a resin. For example, when the bonded magnet is produced from the SmFeN-based anisotropic magnetic powder according to the present embodiments, the obtained bonded magnet can have an improved squareness ratio Hk. The SmFeN-based anisotropic magnetic powder after dispersion may contain fine powder. A higher fine powder content tends to increase the coercive force iHc, and an increased coercive force iHc also tends to increase the squareness ratio Hk. However, since the fine powder is likely to be degraded by heating, a higher fine powder content is likely to reduce the coercive force iHc and the squareness ratio Hk in the production of a magnet from the magnetic powder. For example, when a bonded magnet is produced from the SmFeN-based anisotropic magnetic powder according to the present embodiments as in Example 4 and Comparative Example 4 described later, the coercive force iHc and the squareness ratio Hk of the bonded magnet can be improved compared to those obtained otherwise, probably because the magnetic powder content of the SmFeN-based anisotropic magnetic powder according to the present embodiments is relatively small.

The bonded magnet may contain PPS as the resin. The bonded magnet containing PPS is excellent in water resistance. The molding temperature used to produce the bonded magnet with PPS is, for example, at least 300° C. but not higher than 340° C. If nylon 12 is used, the molding temperature is 250° C., for example. Thus, the molding temperature for PPS can be considered relatively high. A SmFeN-based anisotropic magnetic powder having a higher fine powder content tends to have lower heat resistance. The SmFeN-based anisotropic magnetic powder obtained by dispersion using resin-coated metal media or resin-coated ceramic media hardly forms fine powder and is therefore suitable for producing a bonded magnet with PPS. When the resin used is PPS, the fine powder content of the SmFeN-based anisotropic magnetic powder used, specifically the proportion of fine powder particles relative to the total particles of the SmFeN-based anisotropic magnetic powder, may be not more than 10% or not more than 5%. The SmFeN-based anisotropic magnetic powder may not contain fine powder particles. Here, the term “fine powder particles (fine powder)” refers to particles having a particle size of not more than 0.3 μm.

The remanence Br of the bonded magnet according to the present embodiments can be at least 0.80 T but not more than 1.35 T and may be at least 0.90 T but not more than 1 T. The coercive force iHc can be at least 7500 Oe but not more than 20000 Oe and may be at least 16000 Oe but not more than 20000 Oe. The squareness ratio Hk can be at least 5100 Oe but not higher than 20000 Oe and may be at least 10000 Oe but not higher than 13000 Oe. The maximum energy product BHmax can be at least 16 MGOe but not more than 25 MGOe and may be at least 21 MGOe but not more than 22 MGOe. The ratio Hk/iHc can be at least 0.55 but not higher than 0.90 and may be at least 0.70 but not higher than 0.80.

A sintered magnet can be produced by compacting and sintering the SmFeN-based anisotropic magnetic powder according to the present embodiments. The SmFeN-based anisotropic magnetic powder according to the present embodiments is suitable for sintered magnets because it has a low oxygen concentration, a small average particle size, a narrow particle size distribution, and a high remanence.

For example, the sintered magnet may be produced by sintering the SmFeN-based anisotropic magnetic powder in an atmosphere with an oxygen concentration of not more than 0.5 ppm by volume at a temperature of higher than 300° C. but lower than 600° C. under a pressure of at least 1000 MPa but not more than 1500 MPa, as described in JP 2017-055072 A.

For example, the sintered magnet may be produced by pre-compacting the SmFeN-based anisotropic magnetic powder in a magnetic field of not lower than 6 kOe, followed by warm compaction at a temperature of not higher than 600° C. and a contact pressure of 1 to 5 GPa, as described in WO 2015/199096.

For example, the sintered magnet may be produced by subjecting a mixture containing the SmFeN-based anisotropic magnetic powder and a metal binder to cold compaction at a contact pressure of 1 to 5 GPa, followed by heating at a temperature of 350° C. to 600° C. for 1 to 120 minutes, as described in JP 2016-082175 A.

### EXAMPLES

Examples are described below. It should be noted that “%” is by mass unless otherwise specified.

### Evaluation

The metal contents, average particle size, particle size distribution, circularity, nitrogen content, oxygen content, residual magnetization σr, coercive force iHc, and squareness ratio Hk of the SmFeN-based anisotropic magnetic powder were evaluated as described below. The remanence Br, coercive force iHc, squareness ratio Hk, and maximum energy product BHmax of the bonded magnet were also evaluated as described below.

### Metal Contents

The metal (Sm, Fe, W, etc.) contents of the SmFeN-based anisotropic magnetic powder dissolved with hydrochloric acid were measured by ICP-AES (apparatus name: Optima 8300).

### Average Particle Size and Particle Size Distribution

The average particle size and particle size distribution of the SmFeN-based anisotropic magnetic powder were measured with a laser diffraction particle size distribution analyzer (HELOS & RODOS available from Japan Laser Corporation).

### Circularity

The coefficient of circularity was calculated by taking a SEM image of the SmFeN-based anisotropic magnetic powder at a magnification of 3000 and processing the image for binarization using image processing software (particle analysis Ver. 3 available from Sumitomo Metal Technology, Inc.).

### Nitrogen Content and Oxygen Content

The nitrogen content and oxygen content of the SmFeN-based anisotropic magnetic powder were measured by a heat conductivity method (EMGA-820 available from Horiba, Ltd.).

Residual magnetization σr, coercive force iHc, and squareness ratio Hk of SmFeN-based anisotropic magnetic powder

The obtained SmFeN-based anisotropic magnetic powder was packed together with a paraffin wax into a sample vessel. After the paraffin wax was melted using a dryer, the easy axes of magnetization were aligned in an orientation field of 16 kA/m. The magnetically oriented sample was pulse-magnetized in a magnetizing field of 32 kA/m, and the residual magnetization σr, coercive force iHc, and squareness ratio Hk of the sample were measured using a vibrating sample magnetometer (VSM) with a maximum field of 16 kA/m.

Remanence Br, Coercive Force iHc, Squareness Ratio Hk, and Maximum Energy Product BHmax of Bonded Magnet

The remanence Br, coercive force iHc, squareness ratio Hk, and maximum energy product BHmax of the bonded magnet were measured using a B-H curve tracer available from Riken Denshi Co., Ltd.

### Production Example 1

### Precipitation Step

An amount of 5.0 kg of FeSO₄·7H₂O was mixed and dissolved in 2.0 kg of pure water. Thereto were further added 0.49 kg of Sm₂O₃, 0.035 kg of La₂O₃, 0.006 kg of titanium oxide, and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, to obtain a SmFeLaTi sulfuric acid solution.

The entire amount of the prepared SmFeLaTi sulfuric acid solution was added dropwise with stirring to 20 kg of pure water kept at a temperature of 40° C. over 70 minutes from the start of the reaction, while simultaneously adding dropwise 0.190 kg of a 13% by mass ammonium tungstate solution and a 15% by mass ammonia solution to adjust the pH to 7 to 8. Thus, a slurry containing a SmFeLaWTi hydroxide was obtained. The slurry was washed with pure water by decantation, followed by solid-liquid separation to separate the hydroxide. The separated hydroxide was dried in an oven at 100° C. for 10 hours.

### Oxidation Step

The hydroxide obtained in the precipitation step was fired in the air at 1000° C. for 1 hour. After cooling, a red SmFeLaWTi oxide was obtained as a raw material powder.

### Pretreatment Step

An amount of 100 g of the SmFeLaWTi oxide was put in a steel container to a thickness of 10 mm. The container was placed in a furnace, and the pressure was reduced to 100 Pa. Then, while introducing hydrogen gas, the temperature was increased to a pretreatment temperature of 850° C. and maintained at this temperature for 15 hours. The oxygen concentration was measured by a non-dispersive infrared spectroscopy (ND-IR) (EMGA-820 available from Horiba, Ltd.) and found to be 5% by mass. This shows that a black partial oxide was obtained in which the oxygen bonded to Sm remained unreduced and 95% of the oxygen bonded to Fe was reduced.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced. The temperature was increased to 1060° C. and maintained for 45 minutes to obtain SmFeLaWTi alloy particles.

### Nitridation Step

Subsequently, the temperature inside the furnace was lowered to 100° C., followed by vacuum evacuation. Then, while introducing nitrogen gas, the temperature was increased to a first temperature of 430° C. and maintained for 3 hours. Next, the temperature was increased to a second temperature of 520° C. and maintained for 1 hour, followed by cooling to obtain a magnetic particle-containing bulk product.

### Post Treatment Step

The bulk product obtained in the nitridation step was introduced into 3 kg of pure water and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice. After solid-liquid separation, vacuum drying was performed at 80° C. for 3 hours to obtain a SmFeN-based anisotropic magnetic powder.

### Acid Treatment Step

To 100 parts by mass of the powder obtained in the post treatment was added a 6% aqueous hydrochloric acid solution in an amount equivalent to 4.3 parts by mass of hydrogen chloride, and the mixture was stirred for 1 minute. After standing still, the supernatant was drained by decantation. The introduction into pure water, stirring, and decantation were repeated twice. After solid-liquid separation, vacuum drying was performed at 80° C. for 3 hours to obtain a SmFeN-based anisotropic magnetic powder.

### Production Example 2

### Precipitation Step

An amount of 5.0 kg of FeSO₄·7H₂O was mixed and dissolved in 2.0 kg of pure water. Thereto were further added 0.49 kg of Sm₂O₃, 0.035 kg of La₂O₃, 0.010 kg of strontium carbonate, and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, to obtain a SmFeLaSr sulfuric acid solution.

The entire amount of the prepared SmFeLaSr sulfuric acid solution was added dropwise with stirring to 20 kg of pure water kept at a temperature of 40° C. over 70 minutes from the start of the reaction, while simultaneously adding dropwise 0.190 kg of a 13% by mass ammonium tungstate solution and a 15% by mass ammonia solution to adjust the pH to 7 to 8. Thus, a slurry containing a SmFeLaWSr hydroxide was obtained. The slurry was washed with pure water by decantation, followed by solid-liquid separation to separate the hydroxide. The separated hydroxide was dried in an oven at 100° C. for 10 hours.

An oxidation step, a pretreatment step, a reduction step, a nitridation step, a post treatment step, and an acid treatment step were performed as in Production Example 1.

### Production Example 3

### Precipitation Step

An amount of 5.0 kg of FeSO₄·7H₂O was mixed and dissolved in 2.0 kg of pure water. Thereto were further added 0.49 kg of Sm₂O₃, 0.035 kg of La₂O₃, 0.014 kg of barium carbonate, and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, to obtain a SmFeLaBa sulfuric acid solution.

The entire amount of the prepared SmFeLaBa sulfuric acid solution was added dropwise with stirring to 20 kg of pure water kept at a temperature of 40° C. over 70 minutes from the start of the reaction, while simultaneously adding dropwise 0.190 kg of a 13% by mass ammonium tungstate solution and a 15% by mass ammonia solution to adjust the pH to 7 to 8. Thus, a slurry containing a SmFeLaWBa hydroxide was obtained. The slurry was washed with pure water by decantation, followed by solid-liquid separation to separate the hydroxide. The separated hydroxide was dried in an oven at 100° C. for 10 hours.

An oxidation step, a pretreatment step, a reduction step, a nitridation step, a post treatment step, and an acid treatment step were performed as in Production Example 1.

### Production Example 4

### Precipitation Step

An amount of 5.0 kg of FeSO₄·7H₂O was mixed and dissolved in 2.0 kg of pure water. Thereto were further added 0.49 kg of Sm₂O₃, 0.035 kg of La₂O₃, and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, to obtain a SmFeLa sulfuric acid solution.

The entire amount of the prepared SmFeLa sulfuric acid solution was added dropwise with stirring to 20 kg of pure water kept at a temperature of 40° C. over 70 minutes from the start of the reaction, while simultaneously adding dropwise a 15% by mass ammonia solution to adjust the pH to 7 to 8. Thus, a slurry containing a SmFeLa hydroxide was obtained. The slurry was washed with pure water by decantation, followed by solid-liquid separation to separate the hydroxide. The separated hydroxide was dried in an oven at 100° C. for 10 hours.

### Oxidation Step

The hydroxide obtained in the precipitation step was fired in the air at 1000° C. for 1 hour. After cooling, a red SmFeLa oxide was obtained as a raw material powder.

### Pretreatment Step

An amount of 100 g of the SmFeLa oxide was put in a steel container to a thickness of 10 mm. The container was placed in a furnace, and the pressure was reduced to 100 Pa. Then, while introducing hydrogen gas, the temperature was increased to a pretreatment temperature of 850° C. and maintained at this temperature for 15 hours. The oxygen concentration was measured by a non-dispersive infrared spectroscopy (ND-IR) (EMGA-820 available from Horiba, Ltd.) and found to be 5% by mass. This shows that a black partial oxide was obtained in which the oxygen bonded to Sm remained unreduced and 95% of the oxygen bonded to Fe was reduced.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced. The temperature was increased to a first temperature of 1045° C. and maintained for 45 minutes, and then the temperature was lowered to a second temperature of 1000° C. and maintained for 30 minutes to obtain SmFeLa alloy particles.

### Nitridation Step

Subsequently, the temperature inside the furnace was lowered to 100° C., followed by vacuum evacuation. Then, while introducing nitrogen gas, the temperature was increased to a first temperature of 430° C. and maintained for 3 hours. Next, the temperature was increased to a second temperature of 500° C. and maintained for 1 hour, followed by cooling to obtain a magnetic particle-containing bulk product.

### Post Treatment Step

The bulk product obtained in the nitridation step was introduced into 3 kg of pure water and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice. After solid-liquid separation, vacuum drying was performed at 80° C. for 3 hours to obtain a SmFeN-based anisotropic magnetic powder.

### Production Example 5

### Precipitation Step

An amount of 5.0 kg of FeSO₄·7H₂O was mixed and dissolved in 2.0 kg of pure water. Thereto were further added 0.49 kg of Sm₂O₃, 0.035 kg of La₂O₃, and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, to obtain a SmFeLa sulfuric acid solution.

The entire amount of the prepared SmFeLa sulfuric acid solution and 0.14 kg of a 18% by mass ammonium tungstate solution were added dropwise with stirring to 20 kg of pure water kept at a temperature of 40° C. over 70 minutes from the start of the reaction, while simultaneously adding dropwise a 15% by mass ammonia solution to adjust the pH to 7 to 8. Thus, a slurry containing a SmFeLaW hydroxide was obtained. The slurry was washed with pure water by decantation, followed by solid-liquid separation to separate the hydroxide. The separated hydroxide was dried in an oven at 100° C. for 10 hours.

An oxidation step, a pretreatment step, a reduction step, a nitridation step, and a post treatment step were performed as in Production Example 1, except that the last acid treatment was not performed.

### Example 1

### Dispersion Step

The SmFeN-based anisotropic magnetic powder obtained in Production Example 1 and media (nylon-coated iron core media, diameter: 10 mm, Vickers number of coating nylon: 7, specific gravity: 7.48, thickness of nylon layer: about 1 to 3 mm) were put into a container used in a vibration mill such that the amounts of the SmFeN-based anisotropic magnetic powder and the media were 5% by volume and 60% by volume, respectively, relative to the volume of the container. The powder was dispersed by the vibration mill in a nitrogen atmosphere for 60 minutes to obtain a SmFeN-based anisotropic magnetic powder.

### Example 2

### Dispersion Step

The SmFeN-based anisotropic magnetic powder obtained in Production Example 2 and media (nylon-coated iron core media, diameter: 10 mm, Vickers number of coating nylon: 7, specific gravity: 7.48, thickness of nylon layer: about 1 to 3 mm) were put into a container used in a vibration mill such that the amounts of the SmFeN-based anisotropic magnetic powder and the media were 5% by volume and 60% by volume, respectively, relative to the volume of the container. The powder was dispersed by the vibration mill in a nitrogen atmosphere for 60 minutes to obtain a SmFeN-based anisotropic magnetic powder.

### Example 3

### Dispersion Step

The SmFeN-based anisotropic magnetic powder obtained in Production Example 3 and media (nylon-coated iron core media, diameter: 10 mm, Vickers number of coating nylon: 7, specific gravity: 7.48, thickness of nylon layer: about 1 to 3 mm) were put into a container used in a vibration mill such that the amounts of the SmFeN-based anisotropic magnetic powder and the media were 5% by volume and 60% by volume, respectively, relative to the volume of the container. The powder was dispersed by the vibration mill in a nitrogen atmosphere for 60 minutes to obtain a SmFeN-based anisotropic magnetic powder.

### Comparative Example 1

The SmFeN-based anisotropic magnetic powder obtained in Production Example 4 and media (chromium steel balls, SUJ2, diameter: 2.3 mm, Vickers number: 760, specific gravity: 7.77) were put into a container used in a vibration mill such that the amounts of the SmFeN-based anisotropic magnetic powder and the media were 5% by volume and 60% by volume, respectively, relative to the volume of the container. The powder was dispersed by the vibration mill in a nitrogen atmosphere for 60 minutes to obtain a SmFeN-based anisotropic magnetic powder.

### Comparative Example 2

The SmFeN-based anisotropic magnetic powder obtained in Production Example 5 and media (chromium steel balls, SUJ2, diameter: 2.3 mm, Vickers number: 760, specific gravity: 7.77) were put into a container used in a vibration mill such that the amounts of the SmFeN-based anisotropic magnetic powder and the media were 5% by volume and 60% by volume, respectively, relative to the volume of the container. The powder was dispersed by the vibration mill in a nitrogen atmosphere for 60 minutes to obtain a SmFeN-based anisotropic magnetic powder.

### Comparative Example 3

The SmFeN-based anisotropic magnetic powder obtained in Production Example 4 and media (nylon, diameter: 10 mm, Vickers number: 7, specific gravity: 1.13) were put into a container used in a vibration mill such that the amounts of the SmFeN-based anisotropic magnetic powder and the media were 5% by volume and 60% by volume, respectively, relative to the volume of the container. The powder was dispersed by the vibration mill in a nitrogen atmosphere for 60 minutes to obtain a SmFeN-based anisotropic magnetic powder.

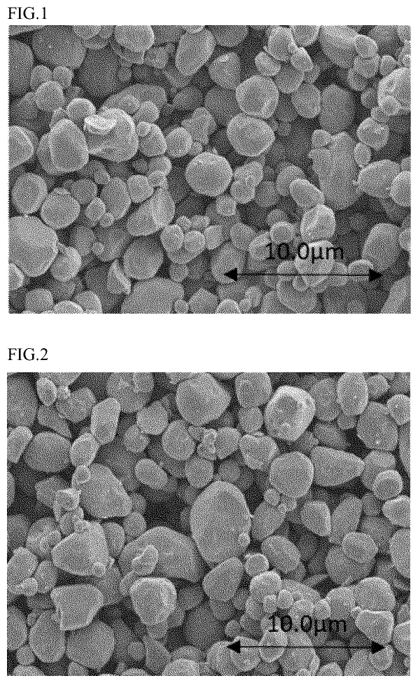

The average particle size, particle size distribution, circularity, residual magnetization σr, coercive force iHc, squareness ratio Hk, oxygen concentration, and nitrogen concentration of the SmFeN-based anisotropic magnetic powders obtained in Examples 1 to 3 and Comparative Examples 1 to 3 were measured as described above, and the results are shown in Table 1. The metal contents were measured, and the results are shown in Table 2. The compositions are shown in Table 3. Moreover, images of the magnetic powders obtained in Examples 1 to 3 and Comparative Examples 1 and 2 were taken with a scanning electron microscope (SU3500, Hitachi High-Technologies Corporation, 5 KV, 5000×). The results are shown in FIG. 1 to FIG. 5.

TABLE 1

| | Particle | | | | | | | | | O | N |
|---|---|---|---|---|---|---|---|---|---|---|---|
| | size | D10 | D50 | D90 | | Circ | σr | iHc | Hk | concentration | concentration |
| | (μm) | (μm) | (μm) | (μm) | Span | (Circularity) | (emu/g) | (Oe) | (Oe) | (%) | (%) |
| Example 1 | 2.76 | 1.32 | 2.72 | 4.19 | 1.06 | 0.820 | 156.4 | 9140 | 5083 | 0.35 | 3.37 |
| Example 2 | 3.32 | 1.49 | 2.94 | 4.97 | 1.18 | 0.840 | 154.0 | 10050 | 5451 | 0.31 | 3.32 |
| Example 3 | 2.86 | 1.32 | 2.75 | 4.57 | 1.18 | 0.832 | 153.1 | 10820 | 5416 | 0.36 | 3.31 |
| Comparative | 3.58 | 1.81 | 3.48 | 5.51 | 1.06 | 0.808 | 148.3 | 7980 | 3027 | 0.33 | 3.33 |
| Example 1 | | | | | | | | | | | |
| Comparative | 2.79 | 1.40 | 2.69 | 4.26 | 1.06 | 0.830 | 148.9 | 11750 | 5431 | 0.46 | 3.40 |
| Example 2 | | | | | | | | | | | |
| Comparative | 4.40 | 2.42 | 4.18 | 6.50 | 0.98 | 0.817 | 139.8 | 7483 | 2357 | 0.18 | 3.37 |
| Example 3 | | | | | | | | | | | |

TABLE 2

| | Content | | | | | | | |
|---|---|---|---|---|---|---|---|---|
| | Sm | Fe | N | La | W | Ti | Sr | Ba |
| | (%) | (%) | (%) | (%) | (%) | (%) | (ppm) | (ppm) |
| Example 1 | 22.5 | 70.6 | 3.37 | 0.24 | 0.3 | 0.15 | — | — |
| Example 2 | 22.6 | 72.9 | 3.32 | 0.37 | 0.3 | — | 5 | — |
| Example 3 | 22.7 | 73.0 | 3.31 | 0.37 | 0.3 | — | — | 10 |
| Comparative | 23.7 | 73.0 | 3.33 | 0.47 | — | — | — | — |
| Example 1 | | | | | | | | |
| Comparative | 22.7 | 75.8 | 3.40 | 0.31 | 0.42 | — | — | — |
| Example 2 | | | | | | | | |
| Comparative | 22.8 | 73.1 | 3.37 | 0.40 | — | — | — | — |
| Example 3 | | | | | | | | |

TABLE 3

| | Composition | | | | | | | |
|---|---|---|---|---|---|---|---|---|
| | Sm | Fe | N | La | W | Ti | Sr | Ba |
| Example 1 | 8.8 | 74.1 | 14.1 | 0.10 | 0.09 | 0.18 | — | — |
| Example 2 | 8.8 | 76.5 | 13.9 | 0.16 | 0.09 | — | 0.0006 | — |
| Example 3 | 8.8 | 76.6 | 13.9 | 0.16 | 0.09 | — | — | 0.0012 |
| Comparative | 9.2 | 76.6 | 13.9 | 0.20 | — | — | — | — |
| Example 1 | | | | | | | | |
| Comparative | 8.6 | 77.3 | 13.8 | 0.13 | 0.13 | — | — | — |
| Example 2 | | | | | | | | |
| Comparative | 8.9 | 76.8 | 14.1 | 0.17 | — | — | — | — |
| Example 3 | | | | | | | | |

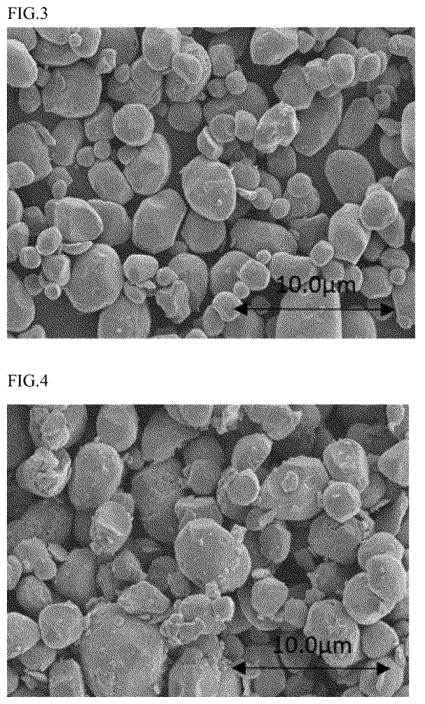

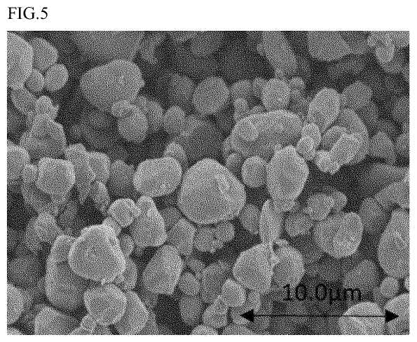

Examples 1 to 3 in which the powders were dispersed using a nylon resin-coated iron core as the media had a higher remanence than those of Comparative Examples 1 and 2 in which the powders were dispersed using non-resin coated chromium steel balls as the media and Comparative Example 3 in which the powder was dispersed using a nylon resin as the media. Moreover, the magnetic powders of Comparative Examples 1 and Comparative Example 2 contained a lot of fine particles as shown in FIG. 4 and FIG. 5, respectively; in contrast, the amount of fine particles was relatively small in Examples 1 to 3, as shown in FIG. 1 to FIG. 3, respectively.

### Example 4

An amount of 250 g of the SmFeN-based anisotropic magnetic powder obtained in Example 1 was introduced into 2 L of pure water to prepare a slurry. To the slurry was added 100 g of 6% hydrochloric acid, and they were stirred until the pH reached 4.5, followed by repeating decantation twice. To the resulting slurry was added a phosphoric acid solution. The phosphoric acid solution was introduced in an amount of 1% by mass, calculated as PO₄, relative to the solids content of the magnetic powder. After stirring for five minutes, the mixture was subjected to solid-liquid separation and then vacuum drying at 200° C. for three hours. Thus, a phosphoric acid-treated SmFeN-based anisotropic magnetic powder was obtained.

An amount of 2.8 g of ethyl silicate (Si₅O₄(OEt)₁₂), 0.4 g of an acidic acetic acid solution, and 1.4 g of ethanol were added to a mixer and mixed for one minute in a nitrogen atmosphere. To the resulting ethyl silicate mixed solution was added 150 g of the phosphoric acid-treated SmFeN-based anisotropic magnetic powder, followed by further mixing for one minute. The resulting magnetic powder mixture was mixed with 2.4 g of ammonia water at pH 12 for one minute. The mixture was taken out from the mixer and then heated under reduced pressure at 180° C. for 30 minutes. Thus, a SmFeN-based anisotropic magnetic powder with a silica thin film formed on its surface was obtained.

An amount of 300 g of the SmFeN-based anisotropic magnetic powder with a silica thin film was mixed with a mixed solution of 1.2 g of a silane coupling agent (γ-aminopropyltriethoxysilane), 0.6 g of ammonia water at pH 11.7 (ammonia content: 10% by mass), and 3.6 g of ethanol in a nitrogen atmosphere for one minute. The mixture was taken out and then heated under reduced pressure at 90° C. for 30 minutes. Thus, a treated SmFeN-based anisotropic magnetic powder with a coupling agent film formed on the silica film was obtained.

### Comparative Examples 4 and 5

The SmFeN-based anisotropic magnetic powders obtained in Comparative Examples 1 and 2 were treated as in Example 4, whereby treated SmFeN-based anisotropic magnetic powders with a coupling agent film formed on a silica film of Comparative Examples 4 and 5, respectively, were obtained.

### Example 5

An amount of 6.6 parts by mass of nylon 12 was mixed with 100 parts by mass of the treated SmFeN-based anisotropic magnetic powder obtained in Example 4 using a mixer. The resulting mixed powder was kneaded at 210° C. using a twin-screw kneader to obtain a bonded magnet compound as a composite material. The bonded magnet compound was injection-molded at a molding temperature of 250° C. using an injection-molding apparatus. Thus, a bonded magnet was produced.

### Example 6

A bonded magnet was produced as in Example 5, except that the molding temperature was 230° C.

### Example 7

An amount of 11 parts by mass of a polyphenylene sulfide resin was mixed with 100 parts by mass of the treated SmFeN-based anisotropic magnetic powder obtained in Example 4 using a mixer. The resulting mixed powder was kneaded at 310° C. using a twin-screw kneader to obtain a bonded magnet compound as a composite material. The bonded magnet compound was injection-molded at a molding temperature of 310° C. using an injection molding apparatus. Thus, a bonded magnet was produced.

### Comparative Example 6

An amount of 6.9 parts by mass of nylon 12 was mixed with 100 parts by mass of the treated SmFeN-based anisotropic magnetic powder obtained in Comparative Example 4 using a mixer. The resulting mixed powder was kneaded at 210° C. using a twin-screw kneader to obtain a bonded magnet compound as a composite material. The bonded magnet compound was injection-molded at a molding temperature of 250° C. using an injection-molding apparatus. Thus, a bonded magnet was produced.

### Comparative Example 7

A bonded magnet was produced as in Comparative Example 6, except that the SmFeN-based anisotropic magnetic powder obtained in Comparative Example 2 was used as the SmFeN-based anisotropic magnetic powder.

### Comparative Example 8

An amount of 13.9 parts by mass of a polyphenylene sulfide resin was mixed with 100 parts by mass of the treated SmFeN-based anisotropic magnetic powder obtained in Comparative Example 5 using a mixer. The resulting mixed powder was kneaded at 310° C. using a twin-screw kneader to obtain a bonded magnet compound as a composite material. The bonded magnet compound was injection-molded at a molding temperature of 310° C. using a mold. Thus, a bonded magnet was produced.

The remanence Br, coercive force iHc, squareness ratio Hk, and maximum energy product BHmax of the bonded magnets obtained in Examples 5 to 7 and Comparative Examples 6 to 8 were measured as described above, and the results are shown in Table 4. Table 4 also shows the filling amount of the magnetic powder, the injection pressure during molding, and the ratio Hk/iHc.

TABLE 4

| | Molding | Filling | Injection | | | | | |
|---|---|---|---|---|---|---|---|---|
| | temperature | amount | pressure | Br | iHc | Hk | BHmax | |
| Example No. | (° C.) | (Vol %) | (MPa) | (T) | (Oe) | (Oe) | (MGOe) | Hk/iHc |
| Example 5 | 250 | 65 | 110 | 0.933 | 16488 | 11794 | 21.40 | 0.72 |
| Example 6 | 230 | 65 | 170 | 0.934 | 17649 | 12282 | 21.40 | 0.70 |
| Example 7 | 310 | 60 | 130 | 0.853 | 9192 | 6354 | 17.50 | 0.69 |
| Comparative | 250 | 65 | 190 | 0.926 | 12586 | 8822 | 20.60 | 0.70 |
| Example 6 | | | | | | | | |
| Comparative | 250 | — | — | 0.773 | 15185 | 7786 | 14.20 | 0.51 |
| Example 7 | | | | | | | | |
| Comparative | 310 | 55 | — | 0.675 | 14206 | 6110 | 10.80 | 0.43 |
| Example 8 | | | | | | | | |

The results demonstrate that the bonded magnets of Examples 5 and 6 containing the SmFeN-based anisotropic magnetic powder of Example 1 and nylon 12 have a higher coercive force iHc, a higher squareness ratio Hk, and a higher maximum energy product BHmax than the bonded magnets of Comparative Examples 6 and 7 containing the SmFeN-based anisotropic magnetic powder of Comparative Example 1 or Comparative Example 2 and nylon 12. The results demonstrate that the bonded magnet of Example 7 containing the SmFeN-based anisotropic magnetic powder of Example 1 and a polyphenylene sulfide resin has a higher remanence Br, a higher squareness ratio Hk, and a higher maximum energy product BHmax than the bonded magnet of Comparative Example 8 containing the SmFeN-based anisotropic magnetic powder of Comparative Example 2 and a polyphenylene sulfide resin.

### INDUSTRIAL APPLICABILITY

The SmFeN-based anisotropic magnetic powder obtained by the production method of the present disclosure has a low oxygen content and excellent magnetic properties, and is therefore suitable for use in bonded magnets or sintered magnets.

What is claimed is:

1. A method of producing a SmFeN-based anisotropic magnetic powder, the method comprising:
preparing a SmFeN-based anisotropic magnetic powder before dispersion containing Sm, Fe, La, W, R, and N, wherein R is at least one selected from the group consisting of Ti, Ba, and Sr; and
dispersing the SmFeN-based anisotropic magnetic powder before dispersion using resin-coated metal media or resin-coated ceramic media.

2. The method of producing a SmFeN-based anisotropic magnetic powder according to claim 1,
wherein the resin-coated metal media or the resin-coated ceramic media have a specific gravity that is at least 4.

3. The method of producing a SmFeN-based anisotropic magnetic powder according to claim 1,
wherein the dispersing is performed in the absence of a solvent.

4. The method of producing a SmFeN-based anisotropic magnetic powder according to claim 1,
wherein the preparing the SmFeN-based anisotropic magnetic powder before dispersion comprises:
a pretreatment comprising heat-treating an oxide containing Sm, Fe, La, W, and R, wherein R is at least one selected from the group consisting of Ti, Ba, and Sr, in a reducing gas-containing atmosphere to obtain a partial oxide;
heat-treating the partial oxide in the presence of a reducing agent to obtain alloy particles;
nitriding the alloy particles to obtain a nitride; and
washing the nitride to obtain the SmFeN-based anisotropic magnetic powder before dispersion.

5. A method of producing a bonded magnet, the method comprising:
producing a SmFeN-based anisotropic magnetic powder by the method according to claim 1; and
mixing the SmFeN-based anisotropic magnetic powder and a resin.

6. The method of producing a bonded magnet according to claim 5,
wherein the resin comprises a polyphenylene sulfide resin.

7. A SmFeN-based anisotropic magnetic powder,
comprising Sm, Fe, La, W, R, and N, wherein R is at least one selected from the group consisting of Ti, Ba, and Sr, and
having an average particle size that is at least 2.0 μm but not more than 4.0 μm, a residual magnetization σr that is at least 152 emu/g, and an oxygen content that is not higher than 0.5% by mass.

8. A bonded magnet, comprising
the SmFeN-based anisotropic magnetic powder according to claim 7, and
a resin.

9. The bonded magnet according to claim 8,
wherein the resin comprises a polyphenylene sulfide resin.

10. The method of producing a SmFeN-based anisotropic magnetic powder according to claim 2, wherein the dispersing is performed in the absence of a solvent.

11. The method of producing a SmFeN-based anisotropic magnetic powder according to claim 2,
wherein the preparing the SmFeN-based anisotropic magnetic powder before dispersion comprises:
a pretreatment comprising heat-treating an oxide containing Sm, Fe, La, W, and R, wherein R is at least one selected from the group consisting of Ti, Ba, and Sr, in a reducing gas-containing atmosphere to obtain a partial oxide;
heat-treating the partial oxide in the presence of a reducing agent to obtain alloy particles;
nitriding the alloy particles to obtain a nitride; and
washing the nitride to obtain the SmFeN-based anisotropic magnetic powder before dispersion.

12. A method of producing a bonded magnet, the method comprising:
producing a SmFeN-based anisotropic magnetic powder by the method according to claim 2; and
mixing the SmFeN-based anisotropic magnetic powder and a resin.
